(19) United States
(12) Patent Application Publication
(10) Pub. No.: US 2005/0036802 A1
(43) Pub. Date: Feb. 17, 2005

(54) Image forming apparatus and process cartridge uses in the same

(75) Inventors: Manabu Saito, Iwatsuki-shi (JP); Hidekazu Amamoto, Iwatsuki-shi (JP); Atsuna Saiki, Iwatsuki-shi (JP); Takaharu Abe, Iwatsuki-shi (JP); Tomoyuki Matsuura, Iwatsuki-shi (JP)

Correspondence Address: OLIFF & BERRIDGE, PLC, P.O. BOX 19928, ALEXANDRIA, VA, 22320, US

(73) Assignee: FUJI XEROX CO., LTD, Tokyo (JP)

(21) Appl. No.: 10/827,323

(22) Filed: Apr. 20, 2004

Related U.S. Application Data
(63) Continuation-in-part of application No. 10/226,305, filed on Aug. 23, 2002, now Pat. No. 6,792,230.
(63) Continuation-in-part of application No. 10/367,881, filed on Feb. 19, 2003, now abandoned.

(30) Foreign Application Priority Data
Dec. 20, 2001 (JP) 2001-388372
Sep. 17, 2002 (JP) 2002-270050

(51) Int. Cl. G03G 21/18

(52) U.S. Cl. 399/111; 399/119

(57) ABSTRACT

A recording medium printed out by an image forming section is ejected to an ejection unit provided at an upper portion of an image forming apparatus. This ejection unit owns an inclination portion which is obliquely formed and has both a lower edge and an upper edge. At least a portion of a developer storage space is arranged in an area “A” which is surrounded by this inclination portion, a horizontal plane extended from the lower edge of the inclination portion, and also, a vertical plane extended from the upper edge of the inclination portion.

This is a Continuation-in-Part of application Ser. No. 10/226,305 filed Aug. 23, 2002, which claims the benefit of Japanese Patent Application No. JP 2001-388372 filed Dec. 20, 2001, and is a Continuation-in-Part of application Ser. No. 10/367,881 filed Feb. 19, 2003, which claims the benefit of Japanese Patent Application No. JP 2002-270050 filed Sep. 17, 2002. The entire disclosure of the prior application is hereby incorporated by reference herein in its entirety.

### BACKGROUND OF THE INVENTION

1. Field of Invention

The present invention is related to an electro-photographic type, or other types of image forming apparatus, and a process cartridge employed in this image forming apparatus.

2. Description of Related Art

As this sort of image forming apparatus, such an image forming apparatus is known in which while a recording medium is transported along a substantially vertical direction, an image is formed on this transported recording medium, and then, the recording medium on which the image has been formed is ejected to an ejection unit provided on an upper portion of a main body of this image forming apparatus as disclosed in JP-A-10-207160.

As previously explained, in such a type of image forming apparatus that the recording medium is transported along the vertical direction, a dead space may be readily formed at a lower portion of the ejection unit. In other words, for instance, in an electro-photographic type image forming apparatus, a developing apparatus is arranged under a vertical transport path, and also, a fixing apparatus is arranged above the vertical transport path, respectively. As a result, a lower portion of an ejection unit, which is extended from the fixing apparatus to a side direction while being inclined, may constitute a dead space.

Also, in an electrophotographic machine as a typical example of this type of image forming apparatus, a latent image is formed on an image carrying bodies such as a photosensitive drum, by a scanning light beam emitted from an optical unit, for example. The latent image is visualized (developed) by using the developer, and transferred onto a recording sheet, such as a recording paper.

In this case, if a two-component developing system, for example, is used, as the toner consumption progresses, toner or toner and carrier are periodically replenished (JP-A-6-12475).

In this type of technique, an image is transferred onto the image carrying body, while transporting the recording sheet in the substantially vertical direction, and scanning light is laterally incident on the image carrying body.

In this case, a toner replenishment box is disposed in downstream (in a lower part in this instance) of a latent image writing position on the image carrying body. Accordingly, the toner replenishment box does not hinder the operation of writing the latent image onto the image carrying body.

However, in this type of technique, the toner replenishment box is disposed in downstream (in a lower part in this instance) of a scanning light incident position. Therefore, for example, when the amount of toner is increased, the toner amount increase more easily affects the positions of a sheet tray and the optical unit, which are disposed in the lower part, since the volume of the toner replenishment box is increased. Changes to the specification of the machine, caused by the toner replenishing amount change, are not uniform. This makes it difficult to use the image forming apparatus in common for different specifications. An additional problem is that with increase of the toner replenishing amount, the machine size tends to increase.

Further, in a case where the machine is designed so as to allow the toner replenishment box to be pulled out from an upper part of the machine body, it entails that it is difficult to install another device in an upper space of the toner replenishment box. An additional technical problem arises that a dead space is easy to be formed in upstream (in an upper part in this instance) of the scanning light incident position.

Particularly in a case where the process cartridge is equipped with the toner replenishment box, such a technical problem is more remarkable by the amount of its occupied space increase.

### SUMMARY OF THE INVENTION

An object of the present invention is to effectively utilize a space just under the inclination portion of the ejection unit, where the dead space may be easily produced.

To achieve an object, a first feature of the present invention is such an image forming apparatus includes an image forming section having a developer storage space into which developer is stored, and an ejection unit for ejecting therefrom a recording medium on which an image has been formed by the image forming section, in which the ejection unit owns an inclination portion which has a lower end and an upper end, while being obliquely formed, and at least a portion of the developer storage space of the image forming section is arranged in an area which is surrounded by the inclination portion, a horizontal plane extended from the lower end of the inclination portion, and a vertical plane extended from the upper end of the inclination portion.

As a consequence, since the developer storage space is arranged in the area which is surrounded by the inclination portion, the horizontal plane extended from the lower end, and the vertical plane extended from the upper end, a lower portion of the inclination portion of the ejection unit can be utilized as the developer storage space.

A second feature of the present invention is such an image forming apparatus includes an image forming section having a developer storage space into which developer is stored, and an ejection unit for ejecting therefrom a recording medium on which an image is formed by the image forming section, in which the ejection unit owns an inclination portion which is obliquely formed, and at least a portion of a wall surface which surrounds the developer storage space along the inclination portion is formed. As a result, since the wall surface of the developer storage space is formed along the inclination portion, the lower portion of the inclination portion of the ejection unit can be similarly utilized as the developer storage space.

The image forming section is not limited only to an ink jet type image forming section, but also not to an electro-photographic type image forming section. However, the electro-photographic type image forming section is preferably employed. In the case of such an electro-photographic image forming system, the image forming section may be arranged by employing an image carrier on which is a latent image is formed; the developer storage space owns a first developer storage portion arranged at an upper portion thereof, and a second developer storage portion arranged at a lower portion thereof, while sandwiching therebetween a horizontal line which is extended from a latent image forming position of the image carrier along a horizontal direction; and the first developer storage portion is connected to the second developer storage portion. Preferably, a developer storage capacity of the first developer storage portion is larger than that of the second developer storage portion.

It should be noted that in the case of the electro-photographic type image forming system, the developer is a toner, or such a mixture made of a toner and a carrier. In the case of the ink jet type image forming system, the developer is ink, and then, a portion of an ink tank is arranged at the lower portion of the ejection unit.

Also, in the case of the electro-photographic type image forming system, the image carrier is a photosensitive member, and an optical writing apparatus for forming a latent image on the image carrier is employed. Furthermore, the optical writing apparatus is constituted by a laser exposing apparatus, and may be arranged at a position which is extended from the latent image forming position of the image carrier to the horizontal direction.

Further, the image forming section may be preferably provided with a process cartridge which includes an image carrier on which a latent image is formed, and a developing unit containing the developer storage, for developing the latent image of the image carrier so as to produce a visible image. This process cartridge may be dismounted and mounted from the upper portion of the apparatus main body by opening/closing the inclination portion. In order to easily detachably mount this process cartridge, a grip portion is provided on a portion of a wall surface which constitutes the developer storage space, and then, the process cartridge may be detachably mounted by handling this grip portion.

Also, a third feature of the present invention is such a process cartridge used in an image forming apparatus containing an ejection unit having an inclination portion which is obliquely formed in order to eject therefrom a recording medium includes a developer storage space for storing thereinto developer, in which at least a portion of the developer storage space is arranged in a space which is surrounded by the inclination portion, a horizontal plane extended from a lower end of the inclination portion, and also, a vertical plane extended from an upper end of the inclination portion.

In addition, a fourth feature of the present invention is such a process cartridge used in an image forming apparatus containing an ejection unit having an inclination portion which is obliquely formed in order to eject therefrom a recording medium includes a developer storage space for storing thereinto developer; in which at least a portion of a wall surface which surrounds the developer storage space is formed along the inclination portion.

It should also be understood that in the present invention, a process cartridge implies such a cartridge having an image carrier on which a latent image is formed, and the developing unit containing the developer storage space and for developing the latent image of the image carrier so as to produce the visible image, and which is freely detachably mounted with respect to the main body of the image forming apparatus. This process cartridge may contain such components as the cleaning apparatus and the charging apparatus.

Another object of the invention is to provide an image forming apparatus, which is capable of efficiently securing a replenishing function of a developer while satisfying requirements of the size reduction and common usability of the image forming apparatus, and with a minimum chance of forming dead space within the apparatus.

According to embodiments of the invention, there is provided an image forming apparatus including a latent image forming unit and a developing unit. The latent image forming unit forms a latent image on an image carrying body. The developing unit visualizes the latent image formed on the image carrying body by using a developer. A developing housing containing the developer is communicatively connected to a developer replenishment box. The developer replenishment box is disposed in an upstream of a latent image writing position on the image carrying body.

### BRIEF DESCRIPTION OF THE DRAWINGS

FIG. 1 is a sectional view for indicating an image forming apparatus according to an embodiment mode of the present invention.

FIG. 2 is a sectional view for representing a process cartridge employed in the image forming apparatus according to an embodiment mode of the present invention.

FIG. 3 is a side view for showing a supply path of developer in the process cartridge employed in the image forming apparatus according to the embodiment mode of the present invention.

FIG. 4 is a perspective view for indicating the process cartridge employed in the image forming apparatus according to the embodiment mode of the present invention.

FIG. 5 is an exploded perspective view for indicating an image carrier unit of the process cartridge employed in the image forming apparatus according to the embodiment mode of the present invention.

FIG. 6 is an exploded perspective view for representing a developing appliance unit of the process cartridge employed in the image forming apparatus according to the embodiment mode of the present invention.

FIG. 7 is a perspective view for showing the developing apparatus unit of the process cartridge employed in the image forming apparatus according to the embodiment mode of the present invention.

FIG. 8 is an exploded perspective view of the developing apparatus unit of the process cartridge employed in the image forming apparatus according to the embodiment mode of the present invention, as viewed from a rear surface of the developing appliance unit.

FIG. 9 is an explanatory diagram interrelatedly showing an image forming apparatus, a process cartridge, and a developing unit, which are based on various exemplary embodiments of the present invention.

FIG. 10 is an explanatory diagram for explaining an overall construction of an image forming apparatus which forms an embodiment 1 of the invention.

FIG. 11 is an explanatory diagram for explaining the details of a process cartridge used in the exemplary embodiment.

FIG. 12 is an exploded perspective view showing a major portion of the process cartridge including a waste developer transporting mechanism.

FIG. 13 is an explanatory diagram for explaining the details of the process cartridge including a waste developer transporting mechanism.

FIG. 14A is an explanatory diagram for explaining the waste developer transporting mechanism, and FIG. 14B is a cross sectional view taken on line B-B in FIG. 14A.

FIG. 15 is an explanatory diagram for explaining a drive force transmitting system of the process cartridge.

FIG. 16 is a view taken in an arrow direction VIII in FIG. 7.

FIG. 17 is a diagram comparatively showing a layout inclusive of the process cartridge in the embodiment and a layout inclusive of the process cartridge, which is illustrated for comparative purpose.

FIG. 18 is an explanatory diagram for exemplarily explaining the attaching/detaching of the process cartridge constructed according to the embodiment.

FIG. 19 is an explanatory diagram for explaining a relationship between the process cartridge and a photosensitive cartridge.

FIG. 20 is an explanatory diagram for explaining a relationship among the process cartridge, developer replenishment box, and waste developer recovering box.

FIG. 21 is an explanatory diagram for exemplarily explaining the replacing work of the developer replenishment box and the waste developer recovering box.

FIG. 22 is an explanatory diagram for explaining modifications of the developer replenishment box and the waste developer recovering box.

### DETAILED DESCRIPTION OF PREFERRED EMBODIMENTS

Referring now to drawings, embodiment modes of the present invention will be described.

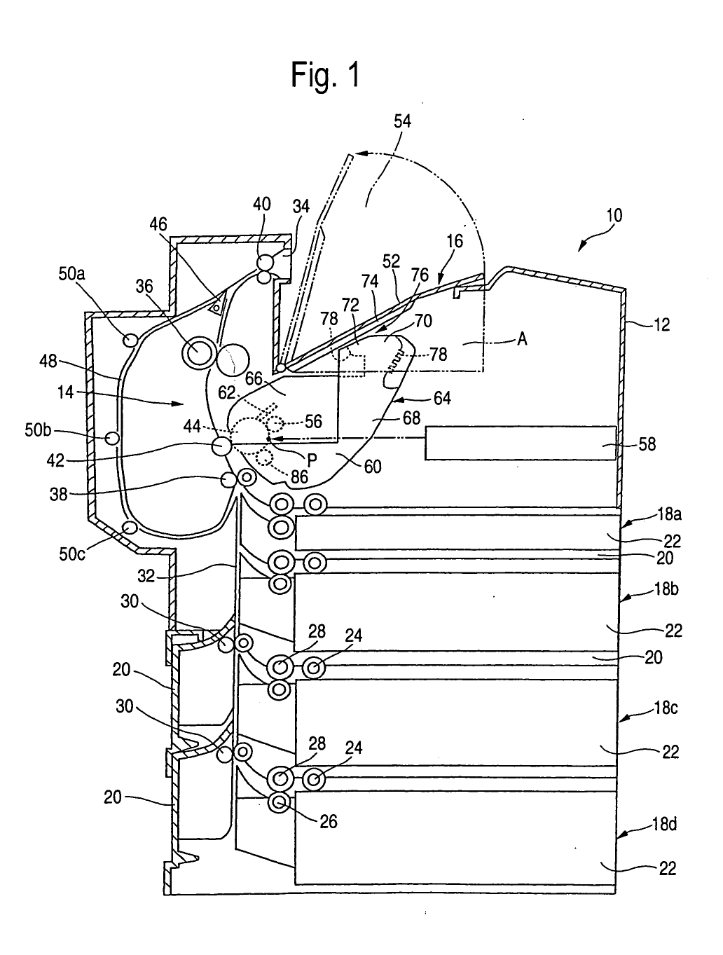

FIG. 1 schematically shows an image forming apparatus 10 according to an embodiment mode of the present invention. The image forming apparatus 10 contains a main body 12 of the image forming apparatus. An image forming section 14 is mounted on this image forming apparatus main body 12. An ejection unit 16 (will be explained later) is provided at an upper portion of this image forming apparatus main body 12, and also, for instance, two stages of paper supply units 18a and 18b are arranged at a lower portion of this image forming apparatus main body 12. Furthermore, two stages of paper supply units 18c and 18d are arranged below the image forming apparatus main body 12, while these paper supply units 18c and 18d are detachably mounted thereon as an optical paper supply unit.

Each of the paper supply units 18a to 18d owns a paper supply unit main body 20 and a paper supply cassette 22 into which paper is stored. The paper supply cassette 22 is slidably mounted with respect to the paper supply unit main body 20, and is drawn out from this paper supply unit main body 20 along a front plane direction (namely, right direction of FIG. 1). Also, a paper supply roller 24 is arranged at an upper portion near an inner end of the paper supply cassette 22, and both a retard roller 26 and a nudger roller 28 are arranged in front of this paper supply roller 24. Furthermore, feed rollers 30 are provided with the optionally-provided paper supply units 18c and 18d, and these feed rollers 30 may constitute a pair of feed rollers.

A transport path 32 corresponds to a paper path defined from the feed roller 30 of the lowermost paper supply unit 18d up to an ejection port 34. While this transport path 32 is located in the vicinity of a rear surface (namely, left side surface viewed in FIG. 1) of the image forming apparatus main body 12, this transport path 32 owns such a portion which is formed along the substantially vertical direction from the feed roller 30 of the lowermost paper supply unit 18d up to a fixing apparatus 36 (will be discussed later). Both a transfer apparatus 42 (will be explained later) and an image carrier 44 (will be explained later) are arranged on an upper stream side of the fixing apparatus 36 of this transport path 32. Furthermore, a register roller 38 is arranged on an upper stream side of both the transfer apparatus 42 and the image carrier 44. In addition, an ejection roller 40 is arranged in the vicinity of an ejection port 34 of the transport path 32.

As a result, the recording mediums which are fed out from the paper supply cassettes 22 of the paper supply units 18a to 18d by the paper supply roller 24 are smoothly separated by the retard roller 26 and the nudge roller 28 to be conducted to the transport path 32, and then, are temporarily stopped by the register roller 38. After proper timing is controlled, a developed image is transferred to the recording medium while the recording medium is penetrated between the transfer apparatus 42 and the image carrier 44 (will be explained later), and this transferred developed image is fixed on the fixing apparatus 36, and then, the recording medium on which the fixed image has been formed is ejected from the ejection port 34 to the ejection unit 16 by the ejection roller 40.

It should be noted that when a double-surface printing mode is carried out, this recording medium is returned to an inversion path 48. In other words, a front path portion of the transport path 30 as to the ejection roller 40 is separated into two paths, a switching craw 46 is provided at this separated path portion, and the inversion path 48 is formed from this separated path portion up to the register roller 38. While transport rollers 50a to 50c are provided in this inversion path 48, in the case of the double-surface printing mode, the switching claw 46 is switched to such a side that the inverted at a time instant when a front edge portion of a recording medium is engaged with the ejection roller 40, so that this recording medium is conducted to the inversion path 48, and then, is penetrated through the register roller 38, the transfer apparatus 42, the image carrier 44, and the fixing apparatus 36 so as to be ejected from the ejection port 34 to the ejection unit 16.

The ejection unit 16 owns an inclination portion 52 which is freely pivotable with respect to the image forming apparatus main body 12. This inclination portion 52 is inclined in such a manner that an ejection port portion thereof is low and is gradually heightened toward a front surface direction (namely, right direction viewed in FIG. 1). This ejection port portion is used as a lower end of the inclination portion 52 and a tip portion which is heightened is used as an upper end thereof. This inclination portion 52 is supported with respect to the image forming apparatus main body 12 in such a manner that this inclination portion 52 is freely pivotable, while the lower end thereof is located at a center. As indicated by a two-dot/dash line in FIG. 1, when this inclination portion 52 is rotated toward the upper direction so as to be opened, an opening unit 54 is formed, and a process cartridge (will be explained later) 64 can be detachably mounted via this opening unit 54.

The image forming section 14 is made of, for instance, an electro-photographic type image forming unit. This image forming section 14 is arranged by the image carrier 44 constructed of a photosensitive material, a charging apparatus 56, an optical writing apparatus 58, a developing apparatus 60, a transfer apparatus 42, a cleaning apparatus 62, and a fixing apparatus 36. The charging apparatus 56 is constituted by, for example, a charge roller capable of uniformly charging the image carrier 44. The optical writing apparatus 58 writes a latent image in an optical manner on the image carrier 44 charged by the charging apparatus 56. The developing apparatus 60 develops the latent image of the image carrier 44, which has been formed by the optical writing apparatus 58, by way of developer so as to produce a visible image. The transfer apparatus 42 is constituted by, for example, a transfer roller which transfers the developed image by the developing apparatus 60 to paper. The cleaning apparatus 62 is constituted by, for instance, a blade which cleans the developer left on the image carrier 44. The fixing apparatus 36 is arranged by both a pressure-applying roller and a heating roller, by which the developed image which has been transferred onto the paper by the transfer apparatus 42 is fixed on this paper. The optical writing apparatus 58 is constructed of, for example, a scanning type laser exposing apparatus, and is arranged in parallel to the paper supply units 18a to 18d, and is located in the vicinity of a front surface of the image forming apparatus main body 12. As will be explained later, the optical writing apparatus 58 exposes the image carrier 44 by scanning light beams across the inner space of the developing apparatus 60. This exposing position of the image carrier 44 may constitute a latent image writing position “P.” It should be noted that in this embodiment mode, the scanning type laser exposing apparatus has been employed as the optical writing apparatus 58. Alternatively, an LED (Light Emitting Diode), a surface emitting laser, and the like may be employed.

The process cartridge 64 is arranged by employing the image carrier 44, the charging apparatus 54, the developing apparatus 60, and the cleaning apparatus 62 in an integral body. This process cartridge 64 is arranged just under the inclination portion 52 of the ejection unit 16, and as previously explained, is detachably mounted via the opening portion 54 which is formed when the inclination portion 52 is opened.

This process cartridge 64 is detachably separated into an image carrier unit 66 and a developing apparatus unit 68. In the image carrier unit 66, the image carrier 44, the charging apparatus 54, and the cleaning apparatus 62 are arranged. In the developing apparatus unit 68, the developing apparatus 60 is arranged. The developing apparatus unit 68 owns a developer storage space 70 which stores thereinto, for example, developer. An upper portion of this developer storage unit 70 belongs to such an area “A” which is surrounded by the inclination portion 52, a horizontal plane extended from the lower end of the inclination portion 52, and also, a vertical plane extended from the upper end of this inclination portion 52 as indicated by a two-dot/dash line in FIG. 1. Also, an upper wall plane 72 which constitutes the developer storage space 70 is formed in such a manner that this upper wall plane 72 is located in parallel to the inclination portion 52 and along this inclination portion 52. Also, a plurality of ribs 74 are formed on a lower surface of the inclination portion 52 in such a way that these plural ribs 74 are positioned in parallel to each other along the inclination direction of the inclination portion 52. Since these ribs 74 are formed, a flow path 76 is formed between the inclination portion 52 and the process cartridge 64. This flow path 76 is employed so as to penetrate air therethrough, and this flow path 76 may disperse heat produced from the fixing apparatus 36. Furthermore, a grip portion 78 is formed on the upper portion of the developer storage space 70. This grip portion 78 is formed in such a manner that wall surfaces of both sides of the upper portion of the developer storage space 70 are entered into the inside thereof. When the process cartridge 64 is detachably mounted, this process cartridge 64 can be readily detachably mounted by gripping this grip portion 78.

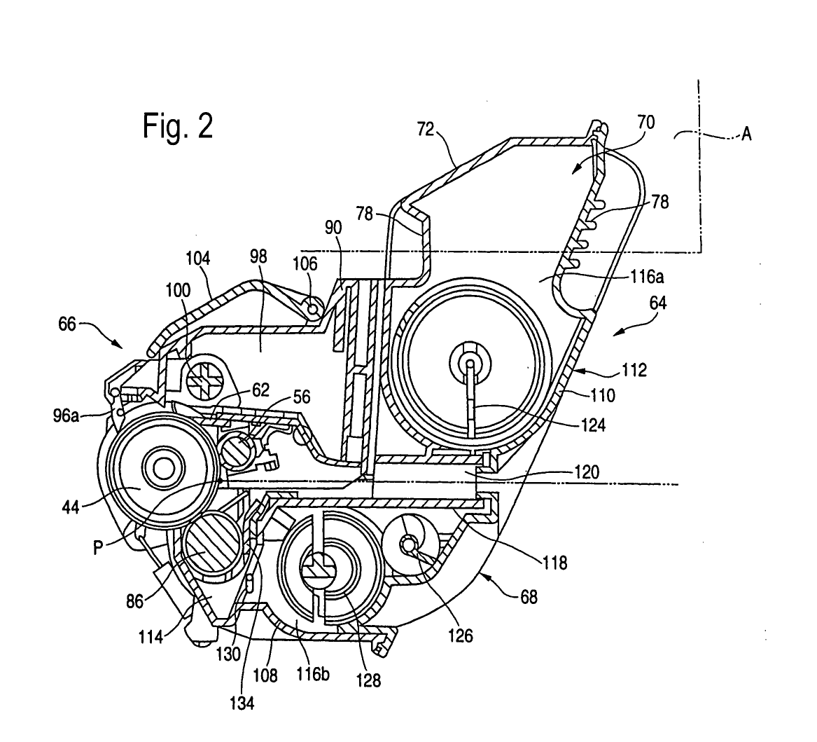

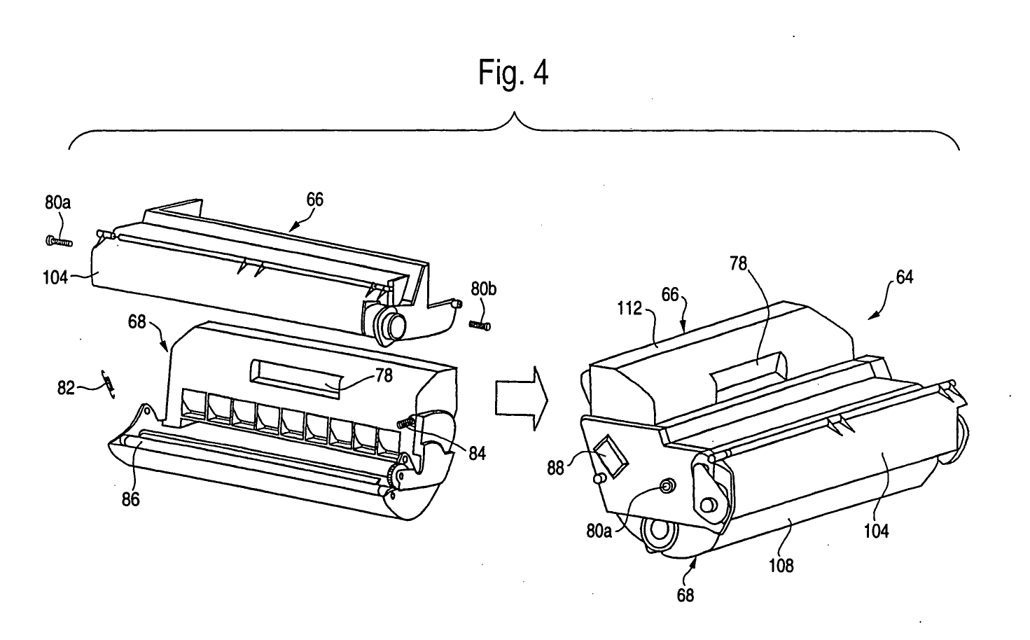

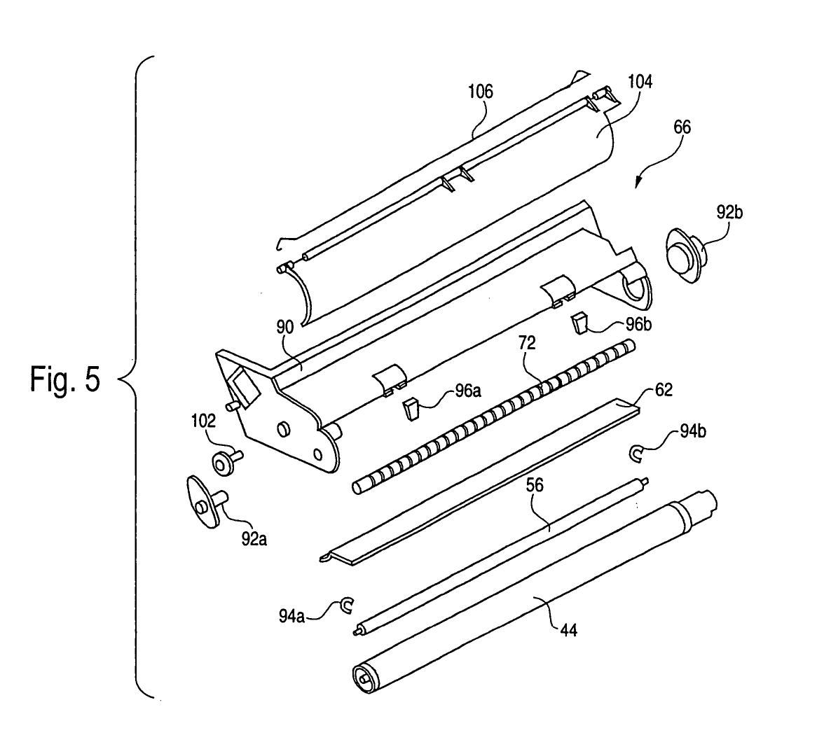

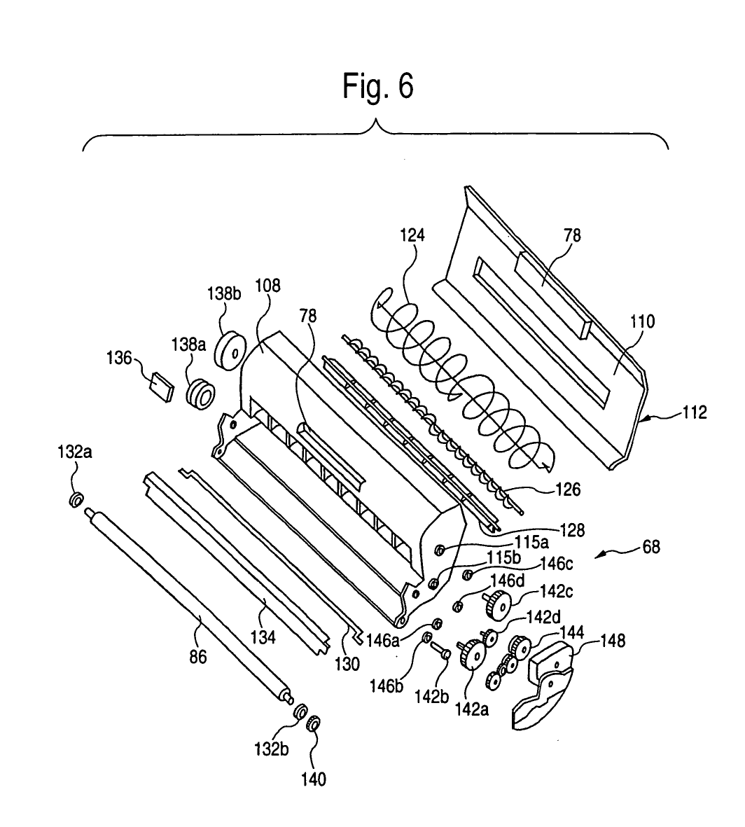

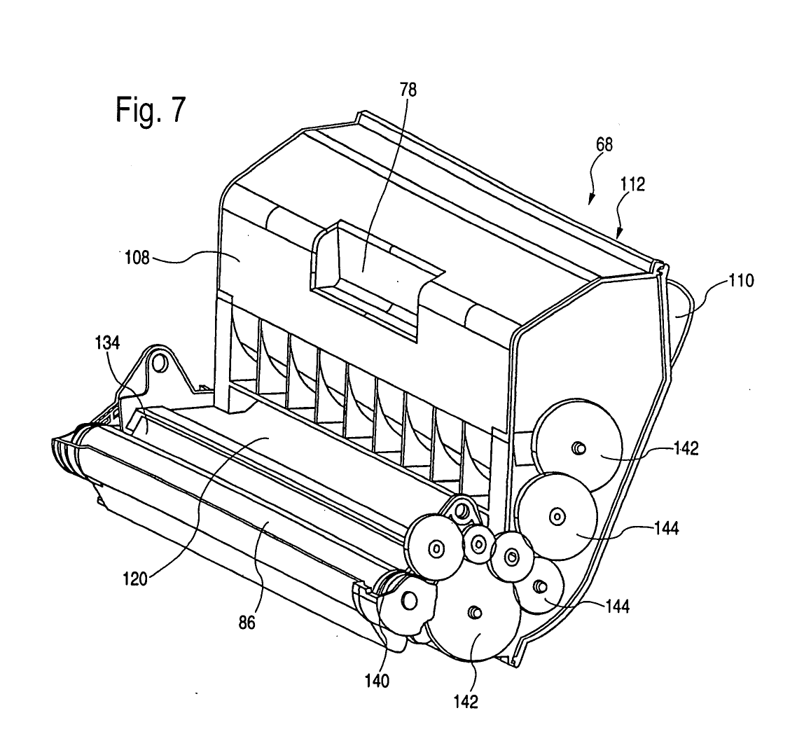

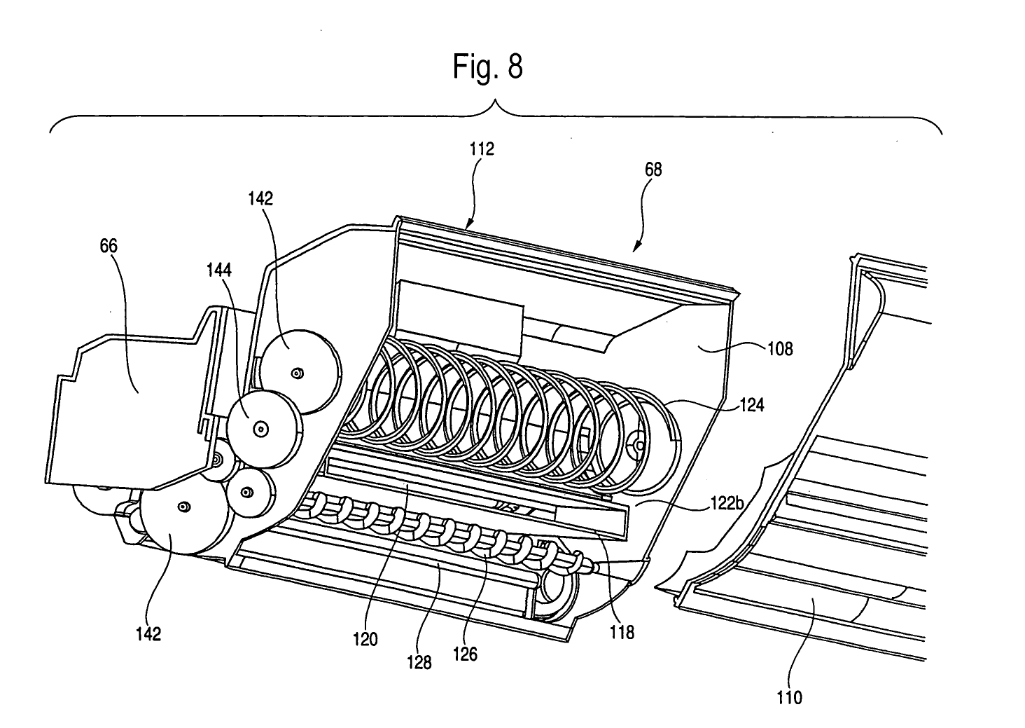

In FIG. 2 to FIG. 8, a detailed construction of the process cartridge 64 is indicated. As explained above, the process cartridge 64 is arranged by the image carrier unit 66 and the developing apparatus unit 68, and this image carrier unit 66 is coupled to the developing apparatus unit 68 via coupling pins 80a and 80b in such a manner that this image carrier unit 66 is freely pivotable with respect to the developing apparatus unit 68. Also, both the image carrier unit 66 and the developing apparatus 68 are energized with each other by a tension spring 82 and a depression spring 84, and a developing roller 86 is depressed against the image carrier 44.

It should also be understood that a memory 88 for storing thereinto a total print number and the like is provided on a side surface of the process cartridge 64 (namely, side surface of one, or both image carrier unit 66 and developing apparatus unit 68).

The image carrier unit 66 owns a main body 90 of the image carrier unit 66, and both the image carrier 44 and the charging apparatus 56 are supported by this image carrier unit main body 90 in such a manner that both the image carrier 44 and the charging apparatus 56 are rotatably supported by this image carrier unit main body 90 via bearing 92a and 93b used for the image carrier 44, and bearings 94a and 94b used for the charging apparatus 56, respectively. The bearing 94a and bearing 94b for the charging apparatus 56 own another function of a power supply portion. Also, for example, two fingers 96a and 96b are supported by the image carrier unit main body 90 in such a manner that these fingers 96a and 96b are freely pivotable with respect to this image carrier unit main body 90. Since tip portions of these fingers 96a and 96b are depressed by a spring for the fingers 96a and 96b on the surface of the image carrier 44, a recording medium which will wrap the image carrier 44 is stripped by these tip portions. Also, a developer collecting space 98 is formed the cleaning apparatus (cleaning blade) 62 within the image carrier unit main body 90, and thus, developer which has been scratched/dropped by the cleaning apparatus 62 is collected into this developer collecting space 98. A paddle 100 is rotatably provided in this developer collecting space 98. This paddle 100 is supported via a gear 102 for the paddle 100 by the image carrier unit main body 90, and transports the developer which has been collected by being rotated to an inner side of the developer collecting space 98. Also, a shutter 104 is provided at the upper portion of the image carrier unit main body 90 in such a manner that this shutter 104 can be freely opened/closed. This shutter 104 is supported via a shaft 106 for the shutter 104 with respect to the image carrier unit main body 90 in a freely movable manner. This shutter 104 closes an opening portion of the image carrier 44 before the process cartridge 64 is mounted, and is opened in order that the image carrier 44 is come out to the front in the case that the process cartridge 64 is mounted.

The developing apparatus unit 68 contains a main body 112 of the developing apparatus unit 68 which is constituted by jointing a front housing 108 to a rear housing 110. An inner space of this developing apparatus unit main body 112 is segmented into the developer collecting space 70 and a developing unit 114 in which the developing roller 86 is arranged. The developer collecting space 70 is separated into a first developer storage portion 116a and a second developer storage portion 116b via a partition wall 118, while a horizontal line extended from the latent image writing position “P” is defined as a boundary. This horizontal line corresponds to a scanning optical path originated from the optical writing apparatus 58. The first developer collecting portion 116a is located at an upper portion of the developer storage portion 116b is located at a lower portion thereof. A developer storage capacity of the first developer storage unit 116a is made larger than a developer storage capacity of the second developer storage unit 116b.

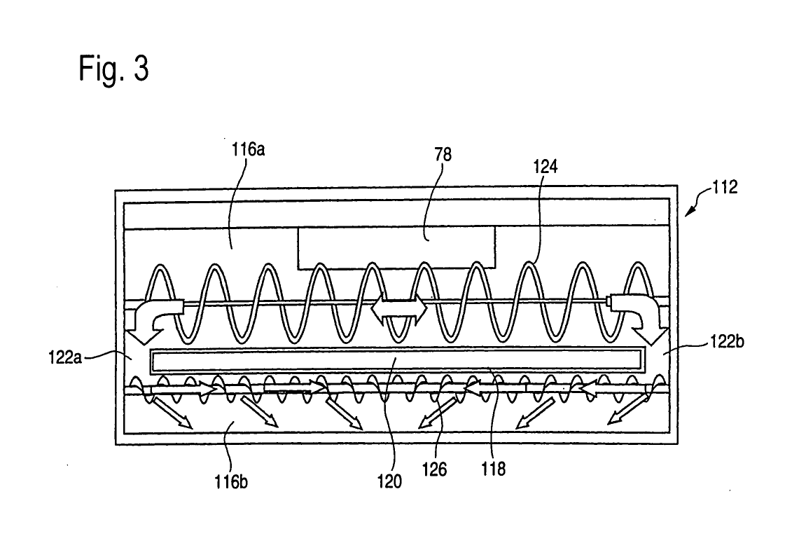

As shown in FIG. 3, the partition wall 118 constitutes a window portion 120 having, for example, a rectangular shape, which forms the optical scanning path defined from the optical writing apparatus 58. Also, this partition wall 118 constitutes developer paths 122a and 122b in connection with the developing apparatus unit main body 112 on both sides of this window portion 120. Both the developer paths 122a and 122b cause the first developer storage portion 116a to be communicated with the second developer storage portion 116b. In the first developer storage portion 116a, as previously explained, an upper portion of this first developer storage portion 116b is arranged within the area “A”, and also, a first stirring/transporting member 124 is rotatably arranged. This first stirring/transporting member 124 is constituted by such a wire member which is formed in a helical shape along different winding directions to each other. The first stirring/transporting member 124 supplies the developer stored in the first developer storage port 116a to the developer paths 122a and 122b. A second stirring/transporting member 126 is rotatably arranged at a lower position of the first stirring/transporting member 124 within the second developer storage unit 116b. This second stirring/transporting member 126 is constituted by a screw shaft formed along different direction from edge portions thereof (viewed along axial direction) toward a center portion thereof. Since the developer is uniformly dispersed by the second stirring/transporting member 124, the developer supplied from the developer paths 122a and 122b formed on the both sides may be transported along the center direction. As a consequence, as indicated by an arrow of FIG. 3, the developer which has been stored in the first developer storage unit 116a is transported to the both sides of the first stirring/transporting member 124 by this first stirring/transporting member 124, and then, is dropped via the developer paths 122a and 122b to the second developer storage unit 116b, and thereafter is uniformly dispersed by rotating the second stirring/transporting member 124, so that the dispersed developer is transported to the side of the developing roller 86.

Furthermore, both a third stirring/transporting member 128 and a fourth stirring/transporting member 130 are arranged in the second developer storage portion 116b. The third stirring/transporting member 128 transports the developer transported by the second stirring/transporting member 126 to the fourth stirring/transporting member 130. This fourth stirring/transporting member 130 is arranged at an output port of the second developing member storage portion 116b. The fourth stirring/transporting member 130 transports the developer which has been transported by the third stirring/transporting member 128 to the developing roller 86, and also, mixes this new developer with the deteriorated developer which has been scratched/dripped from the developing roller 86.

As is well known in the field, the developing roller 86 is constructed in such a manner that a sleeve is wound on a magnet roller, and tracking caps 132a and 132b are provided on both sides of the magnet roller. These tracking caps 132a and 132b are made in contact to the image carrier 44, and as explained in the above description, a developing gap may be secured by depressing these tracking caps 132a and 132b against the image carrier 44 by both the tension spring 82 and the depression spring 84. A layer thickness restricting member 134 made of, for instance, a resin is made in contact with the developing roller 86. A thickness of a developer layer adhered on the surface of the developing roller 86 is restricted by this layer thickness restricting member 134. Also, a side surface of this developing roller 86 is sealed by a developing portion sealing member 136.

It should also be noted that reference numerals 138a and 138b indicate developer caps which are detachably mounted on the developing apparatus unit main body 112. Since these developer caps 138a and 138b are pulled out, the developer is supplied to either the first developer storage unit 116a, or the second developer storage unit 116b.

In the drive system of the process cartridge 64, drive force is transferred from the side of the image carrier 44, and then, is transferred via a developing roller gear 140, a gear 142 for the respective first to fourth stirring/transporting members, and an idle gear 144 to the developing roller 86 and also to the respective first to fourth stirring/transporting members 124 to 130. A stirring/transporting member sealing member 146 is inserted into a bearing portion of the stirring/transporting member gear 146. Furthermore, a gear cover 148 is provided on the side surface of the developing apparatus unit main body 112, while this gear cover 148 covers the gear 142 for the respective stirring/transporting members and the idle gear 144.

Next, operations of the image forming apparatus according to the embodiment mode will now be described.

While the image carrier 44 is uniformly charged by the charging apparatus 56, light emitted from the optical writing apparatus 58 is irradiated onto this charged image carrier 44 in response to an image signal, and then, a latent image is formed at the latent image forming position “P” thereof. The light emitted from the optical writing apparatus 58 passes through the process cartridge 64 via the window portion 120 of the process cartridge 64. The latent image which has been formed on the image carrier 44 by this optical writing apparatus 58 is developed by the developer of the developing apparatus 60 so as to produce a visible image.

While the developer has been stored in both the first developer storage portion 116a and the second developer storage portion 116b, the developer stored in the first developer storage portion 116a is transported to both sides by rotating the first stirring/transporting member 124, and then both the developer located on the both sides is transported via the two developer paths 122a and 122b to the second developer storage unit 116. Furthermore, the developer of the second developer storage portion 116b is uniformly dispersed by rotating the second stirring/transporting member 126, and then, the uniformly dispersed developer is transported to the developing unit 114 by the third stirring/transporting member 128 and the fourth stirring/transporting member 130. In this developing unit 114, the transported developer is adhered onto the developing roller 86, the layer thickness of the adhered developer is restricted by the layer thickness restricting member 134, the thickness restricted developer is transported up to a developing position located opposite to the image carrier 44, and then, an image made of the developer is formed in correspondence with the latent image of the image carrier 44.

On the other hand, one of the paper supply units 18a to 18d is selected in response to a size signal and the like, recording mediums stored in one of these paper supply cassettes 22 are fed out by the paper supply roller 24, and these recording mediums are smoothly separated by the retard roller 26 and the nudger roller 28 so as to conduct a recording medium to the transport path 32. Then, this conducted recording medium is temporarily stopped by the register roller 38, and thereafter, this recording medium is conducted between the transfer apparatus 42 and the image carrier 44 at proper timing.

When the recording medium is conducted between the transfer apparatus 42 and the image carrier 44 in this manner, the developer on the image carrier 44 is transferred to the recording medium by the transfer apparatus 42. This recording medium to which the developer has been transferred is penetrated through the fixing apparatus 36, and then is ejected from the ejection port 34 to the ejection unit 16.

The recording medium is penetrated through the transport path 32, and then is ejected to the ejection unit 16, and thus a so-called “C-path” is constituted, while this transport path 32 is formed along the substantially vertical direction from the paper supply units 18a to 18d arranged along the horizontal direction. In this embodiment mode, since the process cartridge 64 is stored within the C-path, the layout of this image forming apparatus can be made compact. However, if the developer storage space connected to the developing unit 114 is arranged lower than the latent image writing position “P” in the normal design manner, such a dead space is produced under the ejection portion 16. More specifically, in the case that a storage capacity of the developer is increased, since the space located lower than the latent image writing position “P” must be increased, a larger dead space is produced.

However, in this embodiment mode, the window portion 120 which constitutes the scanning optical path from the optical writing apparatus 58 is formed in the process cartridge 64, and the developer paths 122a and 123b are formed on both sides of this window portion 120, and also the first developer storage portion 116a can be arranged above the scanning optical path. Further, a portion of the first developer storage unit 116a is located within the area “A” which is surrounded by the inclination portion 52, the horizontal plane extended from the lower end of the inclination portion 52, and also the vertical plane extended from the upper end of the inclination portion 52. As a result, the lower portion of the ejection unit 16 can be effectively utilized as the developer storage portion.

In the embodiment modes, the one-component developing system is employed. The present invention is not limited to this one-component developing system, but may be applied to a two-component developing system. Also, in the embodiment mode, the developed image is directly transferred from the image carrier to the recording medium. However, the present invention is not limited to this transfer operation, but may be applied to another embodiment in which an intermediate transfer member may be interposed between the image carrier and the recording medium. Furthermore, in the embodiment modes, the black/white image forming apparatus has been described. Apparently, the present invention may be applied to a color image forming apparatus. In this case, for instance, assuming now that four developing apparatus are employed, if a developer storage space of at least one developing apparatus is arranged under the ejection unit, then the dead space problem may be sufficiently solved.

As previously described, in accordance with the present invention, since the lower portion of the ejection unit is used as the developer storage space, this lower portion where the dead space is readily produced can be effectively utilized. As a consequence, the compact image forming apparatus can be provided.

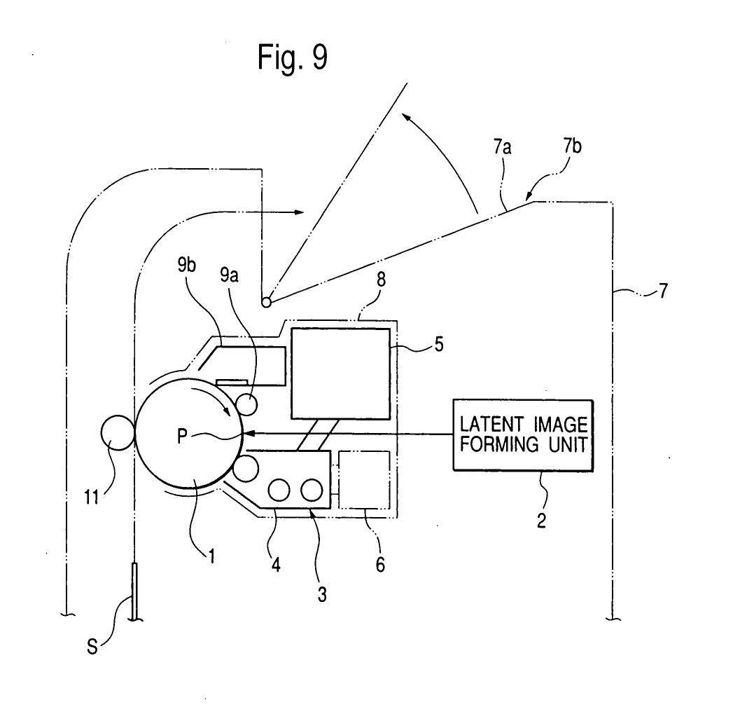

Also according to the present invention, an image forming apparatus has a latent image forming unit 2 and a developing unit 3 as shown in FIG. 9. The latent image forming unit 2 forms a latent image on an image carrying body 1. The developing unit 3 visualizes the latent image formed on the image carrying body 1 by using a developer. For the developing unit 3, a developer replenishment box 5 is communicatively connected to a developing housing 4 in which a developer is contained. The developer replenishment box 5 is disposed in upstream of a latent image writing position P on the image carrying body 1.

It will be understood that the invention can be applied to every image forming apparatus of a type in which a latent image is visualized by the developing unit 3. The invention may be applied to not only the monochrome machine but also the color machine of the tandem type in which a plurality of image carrying bodies 1 are arrayed.

For the developing unit 3, any kind of developer may be used if it is capable of replenishing the developer. The developer may be any of a two-component developer, a one-component developer, and a developer in which magnetic carrier is used for only a carrier medium for transporting supplied toner and the like.

The developer replenishment box 5 involves a variety of containers each capable of replenishing a developer (toner, toner+carrier).

The reason why the latent image writing position P is used as a reference position is that if the developer replenishment box 5 blocks the latent image writing position, it is impossible to form a latent image on the image carrying body 1.

Further, the reason why the wording “upstream of the latent image writing position P” is used is to include sheet paths other than the substantially vertically extending sheet path (in the case of an S-shaped sheet path, for example, the sheet path substantially horizontally extending sheet path is frequent).

The reason why the developer replenishment box 5 is disposed in upstream of the latent image writing position P is that the function of replenishing the developer is realized while effectively utilizing the space within the apparatus, and it is easy to cope with a change of the developer replenishing amount.

Further, this type of image forming apparatus preferably includes a process cartridge 8, which is detachably attached to an apparatus body 7, and into which the image carrying body 1 and at least one process unit 9 (9a: charging unit, for example, 9b: cleaning unit 9b, for example) are incorporated. The developer replenishment box 5 is preferably installed to the process cartridge 8.

In the embodiment, the process cartridge 8 may be attached to and detached from the apparatus body 7, while containing the developer replenishment box 5.

The developer replenishment box 5 may be formed integrally with the process cartridge 8. However, it is preferable to detachably attach the developer replenishment box 5 to the process cartridge 8.

In this case, the developer replenishment box 5 may solely be replaced with another one, and the process cartridge 8 is effectively utilized.

It is also preferable that an image carrying body cartridge including at least the image carrying body 1 is detachably attached to the process cartridge 8.

In this case, the image carrying body cartridge may solely be replaced with another one, and the process cartridge 8 is effectively utilized.

Additionally, it is preferable that the process cartridge 8 may be attached to and detached from the apparatus body 7 from above, by opening an opening/closing cover 7a at the upper part of the apparatus body 7.

In this case, the attaching and detaching operations of the process cartridge 8 can be improved. To remove a recording sheet jammed near a transfer stage, user may access the jamming sheet by detaching the process cartridge 8. Thus, the opening/closing cover 7a is commonly used for both purposes of detaching the process cartridge 8 and removing the paper jam. As a result, the cost of the apparatus body 7 is reduced.

In a case where recovering of the waste developer is required, it is preferred that a waste developer recovering box 6 is integrally attached to the developer replenishment box 5.

The waste developer recovering box 6 involves a variety of containers for recovering the waste developer (which means mainly a deteriorated developer in the developing unit 3, but not exclusive of waste toner gathered after the cleaning).

According to various exemplary embodiments of the present invention, the replenishment of the developer and the recovering of the waste developer are simultaneously carried out (deteriorated developer, waste toner after the cleaning and the like) as well. In this case, there is no need of using an additional cartridge for collecting the waste developer, and the operability can be improved and the cost can be reduced.

The waste developer recovering box 6 is not provided separately from the developer replenishment box 5. Therefore, when the replenishing developer is used up and the developer replenishment box 5 is empty, the waste developer recovering box 6 is also replaced with another box forcibly. Accordingly, if design is made taking the volumes of the developer replenishment box 5 and the waste developer recovering box 6 into account, there is no need of detecting as to whether the waste developer recovering box 6 is full with the waste developer.

Even if the image forming apparatus includes any sheet path, no problem arises. In an image forming apparatus of a type in which a recording sheet S receiving a visual image from the image carrying body 1 by a transfer member 11 is transported from a lower part to an upper part, the developer replenishment box 5 may be disposed on the upper side of the latent image writing position P on the image carrying body 1.

In this case, since the developer replenishment box 5 is disposed in an upper part of the latent image writing position P, a freedom of the layout of the developer replenishment box 5 (it is easy to cope with the increase of the box volume) is increased. In this respect, it is preferable to dispose the developer replenishment box 5 so.

In an image forming apparatus of a type in which the waste developer recovering box 6 is attached to the developer replenishment box 5, the waste developer recovering box 6 may be attached to a desired position. For example, in the case of the waste developer recovering box 6 communicatively connected to the developing housing 4, it is preferable to dispose the waste developer recovering box 6 on the lower side of the latent image writing position P of the image carrying body 1.

Further, in an image forming apparatus of as type which includes a sheet path extending in a substantially vertical direction, a discharge tray 7b in which discharged sheets are contained is preferably provided on the upper side of the developer replenishment box 5.

In this case, the dead space under the discharge tray 7b may be effectively utilized for a space in which the developer replenishment box 5 is installed.

According to various exemplary embodiments of the invention, the upper surface housing of the developer replenishment box 5 is preferably a surface inclined in the same direction as of the discharge tray 7b in which the recording sheets S are contained.

According to the invention, a freedom of the layout of the developer replenishment box 5 is increased (it is easy to cope with the increase of the box volume), and realizing the size reduction of the image forming apparatus is realized by minimizing the dead space under the discharge tray 7b.

It is preferable that the developer replenishment box 5 is capable of containing a larger amount of developer than the developing housing 4 disposed on the lower side of the latent image writing position P on the image carrying body 1.

According to the invention, a freedom of the layout of the developer replenishment box 5 is increased (it is easy to cope with the increase of the box volume).

In an image forming apparatus which is provided with the sheet path extending in the substantially vertical direction, when the developer replenishment box 5 and the developing housing 4 are separately laid out to sandwich the latent image writing position P on the image carrying body 1 therebetween, the developer replenishment box 5 is disposed in an upper part of the latent image writing position P on the image carrying body 1, and the developing housing 4 is disposed in a lower part of the latent image writing position P. It is preferable that the developer replenishment box 5 is communicatively connected to the developing housing 4 by way of a communicative passage, which makes a detour around the latent image writing position P.

The embodiment effectively utilizes the space within the machine, reduces the size of the developing unit 3, and realizes the developer replenishment.

In an image forming apparatus of the type in which the sheet path is substantially vertically directed, and an intermediate transfer member is used, an image forming apparatus has a latent image forming unit 2, a developing unit 3, and an intermediate transfer member (not shown). The latent image forming unit 2 forms a latent image on an image carrying body 1. The developing unit 3 visualizes the latent image formed on the image carrying body 1 by using a developer. The intermediate transfer member temporarily holds the visual image formed on the image carrying body 1, and transfers the visual image onto a recording sheet S. The recording sheet S is transported from a lower part to an upper part.

In this case, for the developing unit 3, a developer replenishment box 5 is communicatively connected to a developing housing 4 in which a developer is contained, and the developing housing 4 and the developer replenishment box 5 are disposed in an upper part of a latent image writing position P on the image carrying body 1. According to the invention, a space under the latent image writing position P on the image carrying body 1 is minimized, and hence the vertical size of the apparatus is reduced.

The intermediate transfer member used is required for enabling the transferring of the visual image to the recording sheet S moving in the substantially vertical direction.

The present invention is not limited to the image forming apparatus mentioned above, but may be applied to the single units i.e., the process cartridge 8 and the developing unit 3, which are used in the image forming apparatus, as shown in FIG. 9.

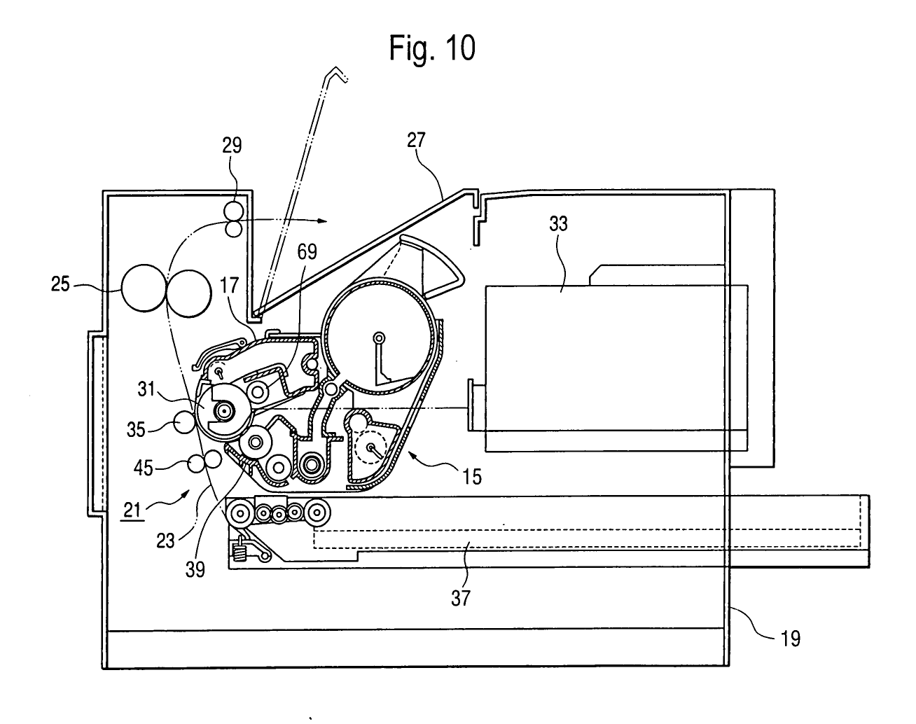

FIG. 10 is an explanatory diagram for explaining an embodiment 1 of an image forming apparatus according to the present invention.

In the figure, the image forming apparatus includes an image forming engine 21, for example, employing an electrophotography system, a sheet supply unit 37, a discharge tray 27, and a sheet transporting path 23. The image forming engine 21 is installed in an apparatus body 19. The sheet supply unit 37 is disposed under the image forming engine 21 in the apparatus body 19. An upper part of the apparatus body 19 is formed as the discharge tray 27. The sheet transporting path 23 is disposed in a rear part (a left side in FIG. 2) in the apparatus body 19 and substantially extends in a vertical direction. The sheet transporting path 23 leads a recording sheet S, which comes from the sheet supply unit 37, to the image forming engine 21 and the discharge tray 27.

In the instant embodiment, the image forming engine 21 is based on the electrophotography system, for example. The image forming engine 21 includes a photosensitive drum 31, a charging unit 69 (charging roll in this instance), an exposure unit 33, a developing unit 39, a transfer unit 35, and a cleaning unit 17. The charging unit 69 charges the photosensitive drum 31. The exposure unit 33 such as a laser scanning device writes an electrostatic latent image (hereinafter referred to as a latent image) on the charged photosensitive drum 31. The developing unit 39 develops the latent image on the photosensitive drum 31 by using toner. The transfer unit (transfer roll in this instance) 35 transfers a visual image (toner image) formed on the photosensitive drum 31 onto the recording sheet S. The cleaning unit 17 removes toner left on the photosensitive drum 31 to clean the photosensitive drum 31.

A register roller 33 for positioning the recording sheet S is provided in an upstream of the photosensitive drum 31 on the sheet transporting path 23. A fixing unit 25 is disposed in a downstream of the photosensitive drum 31 on the sheet transporting path 23. A discharge roll 29 is provided immediately before a discharge tray 27.

In the embodiment, most of devices of the image forming engine 21 are incorporated into a process cartridge 15.

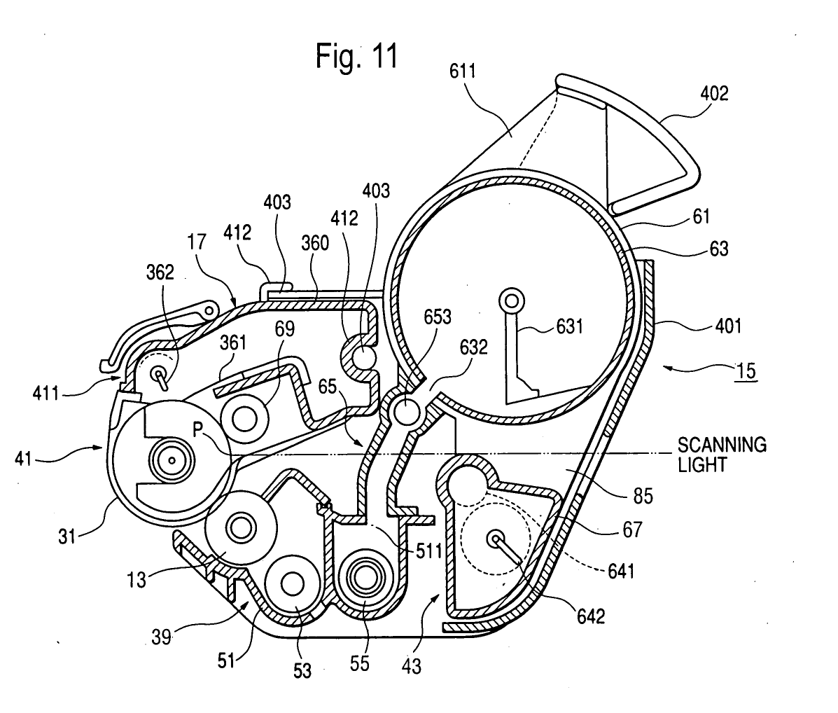

Specifically, the process cartridge 15 used in the instant embodiment, as shown in FIGS. 10 and 11, contains the photosensitive drum 31, charging unit 69, developing unit 39 and cleaning unit 17. The process cartridge 15 is detachably attached to the apparatus body 19. That is, the process cartridge 15 is constructed as so called CRU (customer replaceable unit).

In the instant embodiment, the photosensitive drum 31, charging unit 69 and cleaning unit 17 integrally form a photosensitive cartridge 41. The photosensitive cartridge is detachably attached to the process cartridge 15.

In the photosensitive cartridge 41, the charging unit 69 is disposed in an upstream (on the upper side in this instance) of the latent image writing position P on the photosensitive drum 31. Further, the cleaning unit 17 is disposed in the further upstream thereof.

In the instant embodiment, in the cleaning unit 17, a part of the cartridge case 411 is formed as a cleaning case 360. The cleaning unit 17 includes a cleaning blade 361, which is provided at an opening edge of the cleaning case 360 and in contact with the photosensitive drum 31, and a transporting paddle 362, provided near the opening of the cleaning case 360, for transporting toner left after the cleaning by the cleaning blade 361 to the inner part of the cleaning case 360.

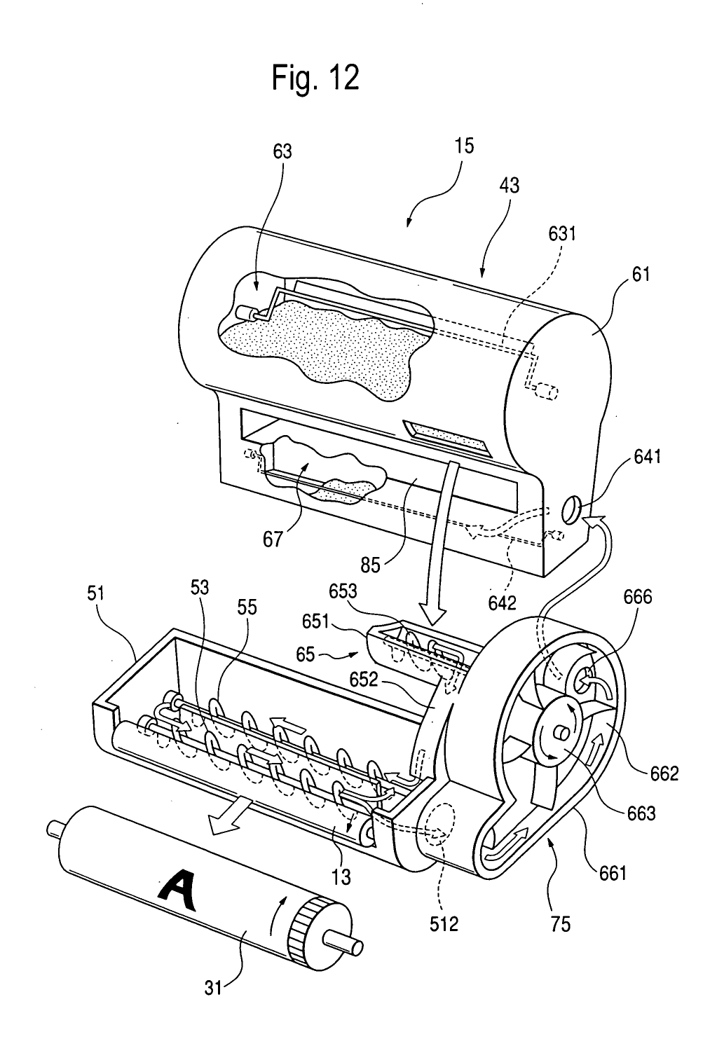

The developing unit 39 is based on the two-component development. As shown in FIGS. 11 and 12, the developing unit includes a developing housing 51 which is located in the downstream (on the lower side in this instance) of the latent image writing position P of the photosensitive drum 31 and opened to the photosensitive drum 31 side. A developing roll 13 is disposed facing the opening of the developing housing 51. A pair of agitating/transporting augers 53 and 54 by which the developer is agitated and transported are provided on the rear side of the developing roll 13. The developer agitated and transferred by the agitating/transporting augers 53 and 54 is transferred to the developing roll 13. A developer layer on the developing roll 13 is regulated in thickness by a trimming member (not shown), and the developer is supplied to a developing position on the photosensitive drum 31.

Further, the developing unit 39 includes a toner cartridge 43, which is located on the rear side of the developing housing 51.

The toner cartridge 43, as shown in FIGS. 11 and 12, is vertically extended astride the latent image writing position P on the photosensitive drum 31. A scanning passage 62 along which scanning light beam emitted from the exposure unit 33 passes is formed at a location of the cartridge case 61, which corresponds to the latent image writing position P. A toner replenishment box 63 is disposed in the upstream (on the upper side in this instance) of the latent image writing position P in the cartridge case 61. A waste developer recovering box 64 is disposed in the downstream (on the lower side in the instance) of the latent image writing position P.

In the instant embodiment, the toner replenishment box 63 is a cylindrical box extending in the axial direction of the developing roll 13. A toner agitator 631 is disposed within this, and agitates and mixes toner so as to prevent the toner from being clustered.

A toner replenishment duct 65 is communicatively connected between the toner replenishment box 63 and the developing housing 51. The toner replenishment duct 65 is positioned out of the scanning passage 62 so as not to interrupt the scanning passage 62.

The toner replenishment duct 65 includes a toner receiving part 651, which correspond to an elongated replenishment port 632 bored in a part of the toner replenishment box 63. The toner replenishment duct includes a connection pipe portion 652, which is communicatively connected from the outer side end of the toner receiving part 651 (as longitudinally viewed) to a replenishment port 511 of the developing housing 51 (which is located at a position which is lower than the replenishment port 632 of the toner replenishment box 63). A dispense auger 653 for supplying the received toner to the connection pipe portion 652 at a rate of a predetermined amount of toner is disposed within the toner receiving part 651.

In the present embodiment, the waste developer recovering box 64 is a box having a deformed fan-shape in cross section, which extends in the axial direction of the developing roll 13. A recovering port 641 is formed at an upper part of the side end of the waste developer recovering box, and a smooth agitator 642 for smoothing the collected waste developer is disposed within the waste developer recovering box.

A discharge port 512 for discharging the waste developer out of the developing housing 51 (the discharge port 512 is located at a position which is lower than the recovering port 641) is bored at one side end of the developing housing 51 as longitudinally viewed. The deteriorated developer is periodically discharged from the developing housing 51, through the discharge port 512.

One or a plurality of discharge ports 512 may be formed at a predetermined height in a normally open state. If required, a shutter, which is opened and closed at appropriate timings, may additionally be provided in association with the discharge port.

A waste developer transporting mechanism 66 is provided between the recovering port 641 of the waste developer recovering box 64 and the discharge port 512 of the developing housing 51.

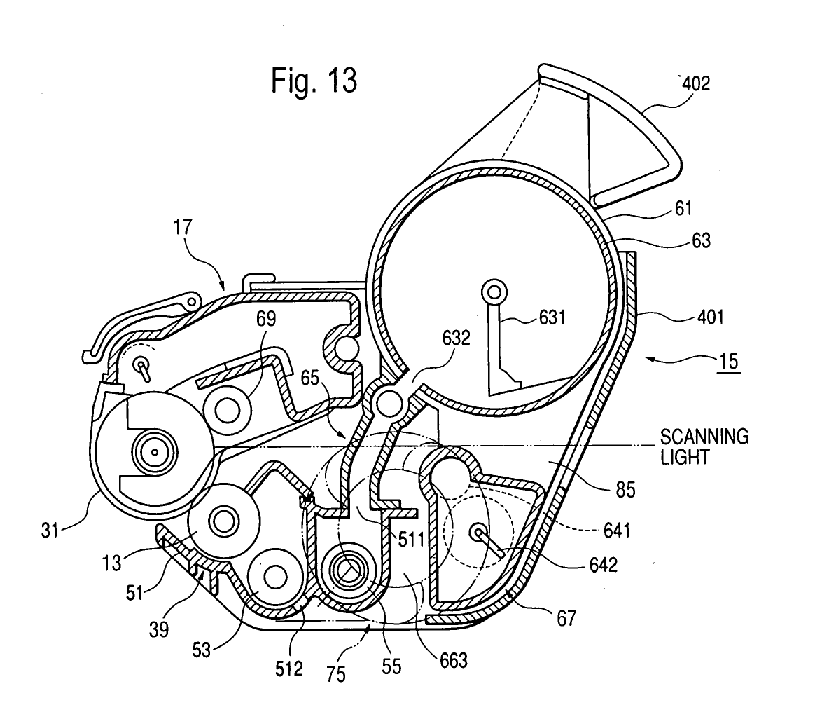

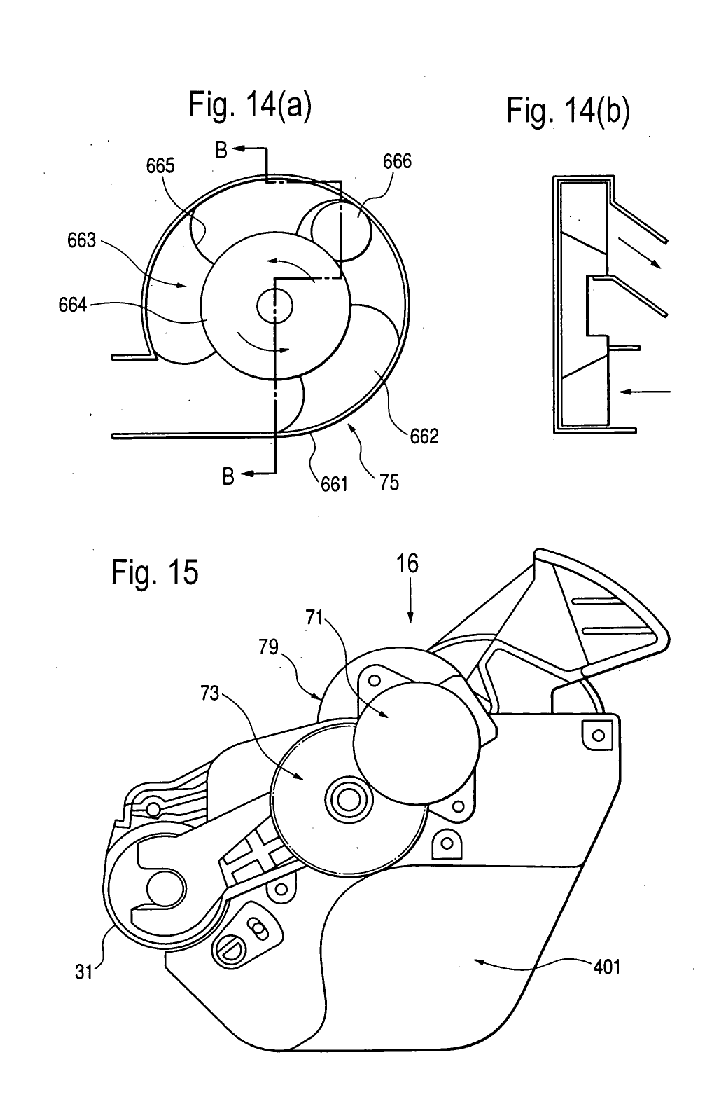

The waste developer transporting mechanism 66, as shown in FIGS. 12 to 13, is disposed on the side of the developing housing 51 and the toner cartridge 43. The recovering port 641 of the waste developer recovering box 64 and the discharge port 512 of the developing housing 51 are interconnected by a connecting duct 661 in a sealing fashion. A part of the connecting duct 661 forms a ring-like space part 662, and a recovering fin 663 is disposed within the ring-like space part 662.

In the recovering fin 663, a plurality of fin members 665 are disposed around the rotor 664 at predetermined angular intervals. The recovering port 641 is disposed at a position of the connecting duct 661 defining the ring-like space part 662, which the position faces a fin moving locus of the recovering fin 663. A communicating port 666 is bored at a part corresponding to the recovering port 641. If the recovering fin 663 is manufactured by resin molding or the like, the cost of it may be reduced.

In the embodiment, the process cartridge 15, as shown in FIG. 11, for example, includes each photosensitive cartridge 41, toner cartridge 43, and a cartridge holder 401 for holding another device. A movable holder 402 for holding down the toner cartridge 43 is provided in the cartridge holder 401 in a swingable manner. By removing an engaging state of the movable holder 402 with an engaging piece 611 of the toner cartridge 43, the toner cartridge 43 is separated from the cartridge holder 401. In FIG. 12, the engaging piece 611 of the toner cartridge 43 is not illustrated.

The process cartridge 15 is provided with a drive force transmitting system 70.

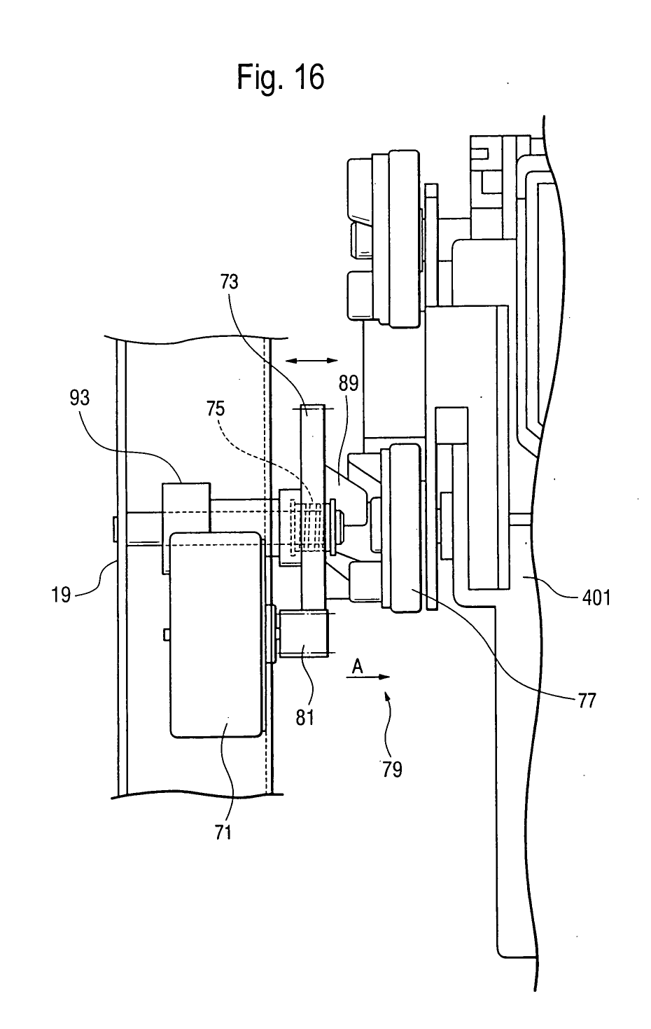

In the drive force transmitting system 70, as shown in FIGS. 15 and 16, a drive motor 71 is fastened to the apparatus body 19. A drive coupling gear 73, which is in mesh with a drive shaft gear 72 of the drive motor 71, is provided with a drive side coupling 74. The developing unit 3 is axially movably supported with respect to the apparatus body 19. The drive coupling gear 73 is urged, by an urging spring 75, in such a direction as to move the drive coupling gear apart from the process cartridge 15. The drive shaft gear 72 and the drive coupling gear 73 are both helical gears. A torque limiter 76 is attached to the shaft of the drive coupling gear 73.

The cartridge holder 401 of the process cartridge 15 includes a CRU side coupling 77, which is removably coupled with the drive side coupling 74.

In the embodiment, the drive force transmitting system 70 operates in the following manner.

When the drive motor 71 is rotated in a predetermined direction, and its rotational force is transmitted, a thrust force having an arrow direction A is generated at a part where the drive shaft gear 72 is in mesh with the drive coupling gear 73, by the rotational direction of the motor and the load of the torque limiter 76. By the thrust force, the drive side coupling 74 is coupled with the CRU side coupling 77, while resisting the urging force by the urging spring 75.

When the drive motor 71 stops, the thrust force disappears at the meshing part between the drive shaft gear 72 and the drive coupling gear 73. As a result, the drive side coupling 74 retracts by the urging force of the urging spring 75, and the drive side coupling 74 is decoupled from the CRU side coupling 77.

To decouple those couplings one from the other, the drive motor 71 is rotated in the direction opposite to the direction in which the motor is rotated when those couplings are coupled. As a result, a thrust force of which is opposite in direction to the thrust force generated when those couplings are coupled is generated at the meshing part between the drive shaft gear 72 and the drive coupling gear 73. In this way, those may be decoupled one from the other.

Where such a coupling removal mechanism is employed, there is no need of using additional parts exclusively used for the decoupling of the couplings. Accordingly, the coupling removal mechanism is simplified correspondingly.

An operation of the thus constructed image forming apparatus which is the embodiment of the invention, will be described.

As shown in FIG. 10, in the process cartridge 15, the photosensitive drum 31 is charged by the charging unit 69, and after a latent image is formed on the photosensitive drum 31 by the exposure unit 33, and it is visualized (into a toner image) by the developing unit 39.

A recording sheet is fed to the sheet transporting path 23 at a predetermined timing, from the sheet supply unit 37, and it is positioned by the register roller 33 and then to a transfer stage.

The toner image is transferred from the photosensitive drum 31 onto the recording sheet by the transfer unit 35, and the toner image, not yet fixed, is fused and fixed on the recording sheet by the fixing unit 25, and the sheet having undergone the fixing process is discharged into the discharge tray 27. The residual toner on the photosensitive drum 31 is removed by the cleaning unit 17.

During such an image forming process, a scanning light beam emitted from the exposure unit 33 reaches the latent image writing position P on the photosensitive drum 31, through the scanning passage 62 of the process cartridge 15. Therefore, there is no chance that the process cartridge 15 impairs the exposure scanning performance of the exposure unit 33.

In the developing unit 39, as the image forming process progresses, the amount of toner consumption increases, and new tone is successively replenished from the toner replenishment box 63 to the developing housing 51 by way of the toner replenishment duct 65 in accordance with an algorithm of toner replenishment control unit, not shown.

The new toner replenished into the developing housing 51, and the developer in the developing housing 51 is agitated and mixed together by the agitating/transporting augers 53 and 54. The thus mixed one is supplied to the developing roll 13, while retaining a predetermined charging characteristic. The developer held by the developing roll 13 is supplied to the developing area associated with the photosensitive drum 31.

In the developing unit 39, part of the developer in the developing housing 51 is not used for the development, and circulated within the developing housing 51 by the agitating/transporting augers 53 and 54.

Such an developer has been deteriorated and it is difficult for the developer to retain the charging characteristic. In the embodiment, the waste developer (mainly deteriorated developer) is discharged from the discharge port 512 of the developing housing 51 periodically or predetermined timings.

The waste developer, as shown in FIGS. 12 and 13, is transported into the recovering fin 663 in the waste developer transporting mechanism 66, and dropped into and collected by the waste developer recovering box 64 through the recovering port 641 of the waste developer recovering box 64, and is agitated by the smooth agitator 642.

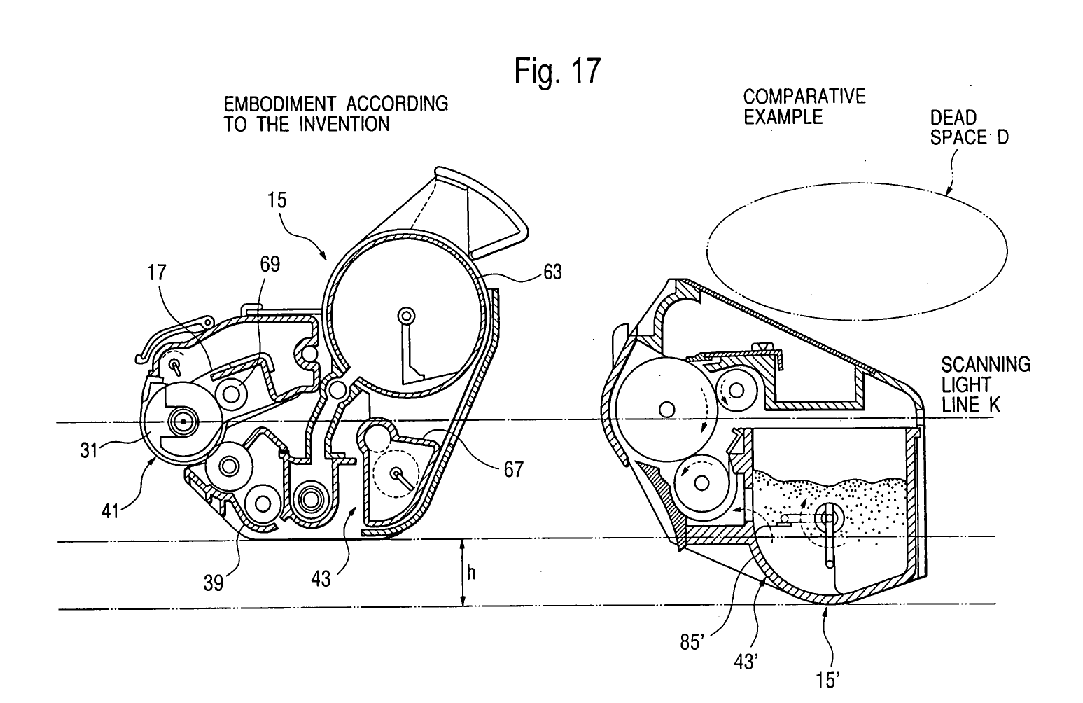

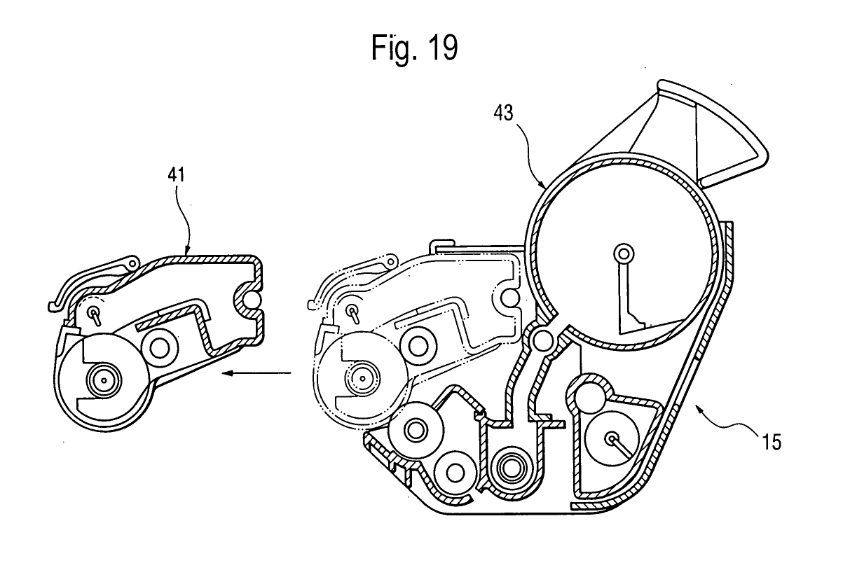

A layout of the process cartridge 15 within the apparatus body 19 is shown in FIG. 17.

A comparative example used here is a process cartridge 15′ incorporating thereinto a toner cartridge 43′ (equipped with only a toner replenishment box 63 in this instance), which is located downstream (on the lower side in this instance) of the latent image writing position P on the photosensitive drum 31.

The process cartridge 15 of the embodiment is compared with the process cartridge 15′ of the comparative example. The bottom of the process cartridge 15 of the instant embodiment is higher than that of the comparative example by “h”. With this feature, there is eliminated a layout limit imposed onto the sheet supply unit 37 and the like, which are disposed in a lower part of the apparatus body 19.

In the embodiment, the toner replenishment box 63 is disposed upstream (on the upper side in this instance) of the latent image writing position P on the photosensitive drum 31. Therefore, a space occupied by the process cartridge in an upper part of the scanning light line “k” in the apparatus body 19 is increased and larger than that in the comparative example.

As recalled, in the comparative example, the space in the lower part of the discharge tray 27 within the apparatus body 19 is the dead space D. The instant embodiment effectively utilizes this dead space D, and uses it merely as a space occupied by the toner replenishment box 63. Therefore, when the process cartridge 15 of the embodiment is used, there is no need of greatly changing the specifications on the upper part of the apparatus body 19.

Even in such a case of increasing the toner replenishing amount of the toner replenishment box 63, if the space of the upper part within the apparatus body 19 is effectively used, it is required to little change the specifications on the upper part (vicinal region around the discharge tray 27) of the apparatus body 19.

For this reason, in constructing the image forming apparatuses of various specifications, the apparatus body 19 may be used in common for those different image forming apparatuses.

Even in a case where the upper part specifications of the apparatus body 19 are unavoidably changed, such a minute change of the specifications as somewhat raising of the discharge tray 27, suffices. As in the comparative example where the space in the lower part of the apparatus body 19 is limited, the specification must greatly be changed, for example, the layout in the sheet supply unit 37 is changed. In the instant embodiment, by contrast, there is no need of greatly changing the specifications.

The attaching and detaching operations of the process cartridge 15, which is constructed according to the invention, will be described hereunder.

In the embodiment, a cartridge receiving part 80 to and from which the process cartridge 15 is attached and detached is provided within the apparatus body 19. The cartridge receiving part 80 is provided with a guide part 81 which consists of, for example, a groove. A guided part of the cartridge holder 401 of the process cartridge 15 slidably engages the groove.

Also in the embodiment, a part of the bottom wall of the discharge tray 27 is formed as an opening/closing cover 82. An opening formed when the opening/closing cover 82 is opened, is used as a work opening 83, which is used for the attaching and detaching operations of the process cartridge 15.

To pulled out the process cartridge 15 from the apparatus body 19, as shown in FIG. 18, for example, the opening/closing cover 82 is opened, and one pulls out the process cartridge 15 from the cartridge receiving part 80 of the apparatus body 19, through the work opening 83.

In this state, when the photosensitive cartridge 41, for example, is replaced with another cartridge, one removes the photosensitive cartridge 41 from the process cartridge 15 as shown in FIG. 11.

As shown in FIG. 11, the cartridge case 411 of the photosensitive cartridge 41 includes an engaging part 412, which may engage with and disengage from engaged parts 403 in the cartridge holder 401. With the aid of the engaging part, the cartridge case is positioned to and detachably attached to the cartridge holder 401.

In the embodiment, the toner cartridge 43 may be detached from the process cartridge 15.

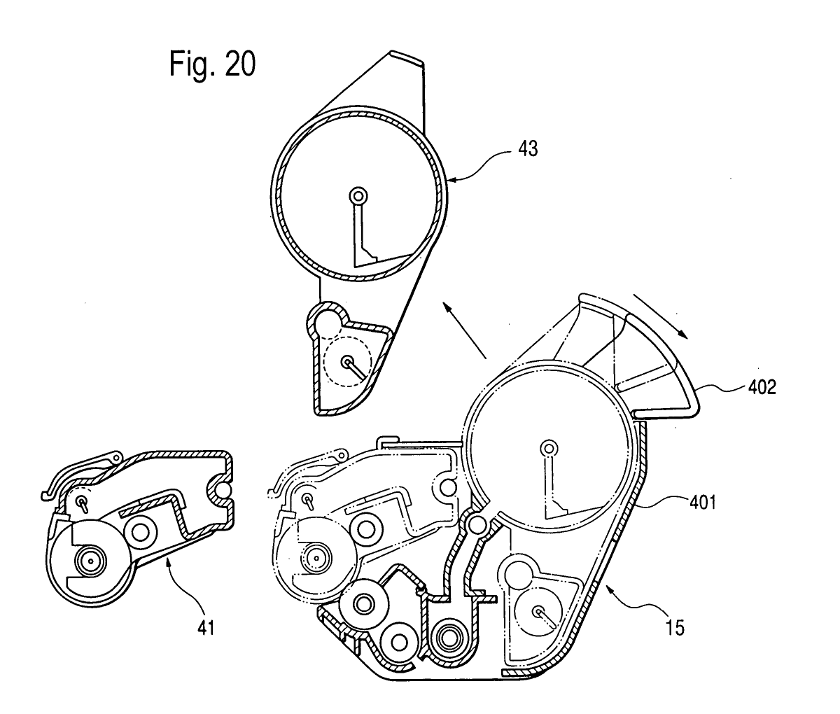

In this case, as shown in FIG. 20, the movable holder 402 of the cartridge holder 401 is turned and moved to release the toner cartridge 43 from its constrained state by the movable holder 402. Thereafter, one pulls the toner cartridge 43 upward from the cartridge holder 401.

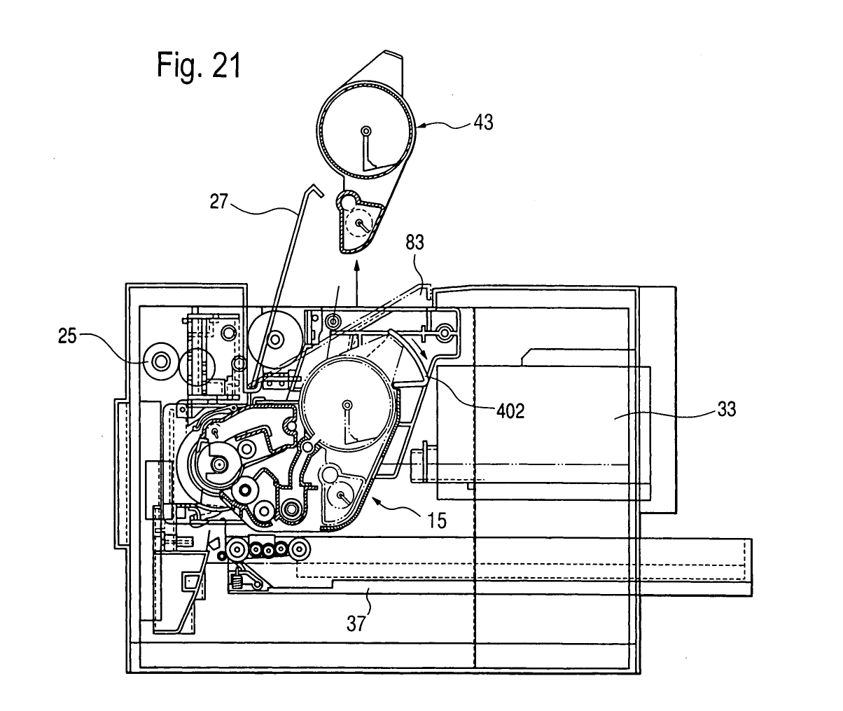

In the embodiment, the toner cartridge 43 may be replaced with another cartridge after the process cartridge 15 is pulled out of the developing unit apparatus body 19. The toner cartridge 43 may be replaced, without taking the process cartridge 15 off the apparatus body 19, in a manner that as shown in FIG. 21, the restraining state of the toner cartridge 43 by the movable holder 402 is removed, and thereafter, the toner cartridge 43 is pulled out the toner cartridge 43 from the process cartridge 15 in the upward direction. When this method is used, the replacing work of the toner cartridge 43 is maintained in good conditions.

Particularly, in the instant embodiment, the photosensitive cartridge 41 and the toner cartridge 43 are detachably attached to the process cartridge 15, and hence the life times of those cartridges are different from one another. However, it is preferable to use those cartridges till those are expired in life time.

In the embodiment, the toner replenishment box 63 and the waste developer recovering box 64 are incorporated into the toner cartridge 43. Therefore, if the toner cartridge 43 is replaced with another toner cartridge, the toner replenishment box 63 and the waste developer recovering box 64 are also replaced both at once with new ones.

Accordingly, in the embodiment, there is no need of using an additional cartridge for collecting the waste toner. In this respect, the operability improvement and the cost reduction are both achieved. A replenishment toner emptiness is detected and the replacing timing of the toner cartridge 43 is determined by using the emptiness. Therefore, there is no need of detecting the waste developer fullness of the waste developer recovering box 64.

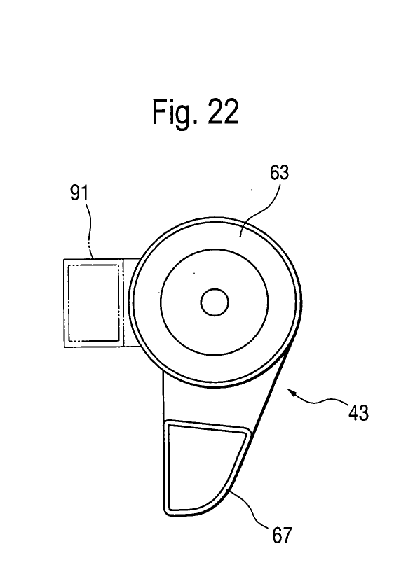

In the embodiment, the toner cartridge 43 is provided with the toner replenishment box 63 and the waste developer recovering box 64. If necessary, a waste developer recovering box 68 which receives waste toner from the cleaning unit 17 and stores the waste toner may be attached additionally, for example, as shown in FIG. 22.

1. An image forming apparatus comprising:
an image forming section having a developer storage space into which developer is stored; and
an ejection unit that ejects therefrom a recording medium on which an image has been formed by the image forming section, wherein the ejection unit owns an inclination portion which has a lower end and an upper end, while being obliquely formed, and
at least a portion of the developer storage space of the image forming section is arranged in an area which is surrounded by the inclination portion, a horizontal plane extended from the lower end of the inclination portion, and a vertical plane extended from the upper end of the inclination portion.

2. An image forming apparatus comprising:
an image forming section having a developer storage space into which developer is stored; and
an ejection unit that ejects therefrom a recording medium on which an image is formed by the image forming section, wherein
the ejection unit owns an inclination portion which is obliquely formed, and
at least a portion of a wall surface which surrounds the developer storage space along the inclination portion is formed.

3. The image forming apparatus according to claim 1, wherein
the image forming section includes an image carrier, an optical writing apparatus for forming a latent image on the image carrier, and a developing apparatus containing the developer storage space, for developing the latent image of the image carrier so as to produce a visible image,
the developer storage space owns a first developer storage portion arranged at an upper portion thereof, and a second developer storage portion arranged at a lower portion thereof, while sandwiching therebetween a horizontal line which is extended from a latent image forming position of the image carrier by the optical writing apparatus along a horizontal direction, and
the first developer storage portion is connected to the second developer storage portion.

4. The image forming apparatus according to claim 3, wherein
a developer storage capacity of the first developer storage portion is larger than that of the second developer storage portion.

5. The image forming apparatus according to claim 4, wherein
the optical writing apparatus is constituted by a laser exposing apparatus, and is arranged at a position which is extended from the latent image forming position of the image carrier to the horizontal direction.

6. The image forming apparatus according to claim 1, wherein
the image forming section includes a process cartridge which includes an image carrier on which a latent image is formed, and a developing unit containing the developer storage, for developing the latent image of the image carrier so as to produce a visible image.

7. The image forming apparatus according to claim 6, wherein
the inclination portion can be freely opened/closed, and the process cartridge can be detachably mounted via an opening portion which is formed when the inclination portion is opened.

8. The image forming apparatus according to claim 6 further comprising:
a paper supplying apparatus having a supply unit for supplying the recording medium;
a transfer apparatus provided opposite to the image carrier of the process cartridge;
a fixing apparatus arranged on the down-stream side of the transfer apparatus; and
a transport path that transports the recording medium supplied from the supply unit of the paper supplying apparatus between the image carrier and the transfer apparatus, and for ejecting the recording medium via the fixing apparatus to the ejection unit, wherein
a portion of the transport path defined from the supply unit of the paper supply apparatus up to the fixing apparatus is formed along a substantially vertical direction.

9. The image forming apparatus according to claim 1, wherein
the inclination portion of the ejection unit has the lower end in the vicinity of an exit port from which the recording medium is ejected, and is heightened toward the upper end of the inclination portion.

10. The image forming apparatus according to claim 6, wherein
a grip portion is provided on the wall surface which surrounds the developer storage space.

11. The image forming apparatus according to claim 10, wherein
the grip portion is formed in such a manner that the grip portion is entered into an inner side of a wall surface of the grip portion.

12. The image forming apparatus according to claim 2, wherein
a flow path that causes air to pass therethrough is formed between the ejection portion and the wall surface.

13. The image forming apparatus according to claim 12, wherein
the flow path is constructed of a rib which is formed on at least one of the ejection unit and the wall surface.

14. The image forming apparatus according to claim 13, wherein
the rib is formed along an ejection direction of the recording medium which is ejected to the ejection unit.

15. A process cartridge used in an image forming apparatus containing an ejection unit having an inclination portion which is obliquely formed in order to eject therefrom a recording medium comprising:
a developer storage space that stores thereinto developer, wherein
at least a portion of the developer storage space is arranged in a space which is surrounded by the inclination portion, a horizontal plane extended from a lower end of the inclination portion, and also, a vertical plane extended from an upper end of the inclination portion.

16. A process cartridge used in an image forming apparatus containing an ejection unit having an inclination portion which is obliquely formed in order to eject therefrom a recording medium comprising:
a developer storage space that stores thereinto developer, wherein
at least a portion of a wall surface which surrounds the developer storage space is formed along the inclination portion.

17. An image forming apparatus comprising:
a latent image forming unit that forms a latent image on an image carrying body; and
a developing unit that visualizes the latent image formed on the image carrying body by using a developer,
wherein a developing housing containing the developer is communicatively connected to a developer replenishment box; and
wherein the developer replenishment box is disposed in an upstream of a latent image writing position on the image carrying body.

18. The image forming apparatus according to claim 17, further comprising a process cartridge detachably attached to the apparatus body, the process cartridge into which the image carrying body and at least one process unit are incorporated,
wherein the process cartridge includes the developer replenishment box.

19. The image forming apparatus according to claim 18, wherein the developer replenishment box is detachably attached to the process cartridge.

20. The image forming apparatus according to claim 18, wherein an image carrying body cartridge including at least the image carrying body is detachably attached to the process cartridge.

21. The image forming apparatus according to claim 18, wherein the process cartridge is attached to and detached from the apparatus body by opening an opening/closing cover provided in an upper part of the apparatus body.

22. The image forming apparatus according to claim 17, further comprising a waste developer recovering box integrally attached to the developer replenishment box.

23. The image forming apparatus according to claim 17,
wherein a recording sheet onto which a visual image is transferred from the image carrying body is transported from a lower part to an upper part; and
wherein the developer replenishment box is disposed on an upper side of the latent image writing position on the image carrying body.

24. The image forming apparatus according to claim 23, further comprising a discharge tray for accommodating discharged sheets, disposed in an upper part of the developer replenishment box.

25. The image forming apparatus according to claim 24, wherein an upper surface housing of the developer replenishment box is an inclined surface inclined in the same direction as of the discharge tray accommodating the recording sheets.

26. The image forming apparatus according to claim 23, wherein the developer replenishment box is capable of containing a larger amount of developer than the developing housing disposed in a lower side of the latent image writing position on the image carrying body.

27. The image forming apparatus according to claim 23,
wherein the developer replenishment box is disposed in an upper part of a latent image writing position on the image carrying body;
wherein the developing housing is disposed in a lower part of the latent image writing position; and
wherein the developer replenishment box is communicatively connected to the developing housing by way of a communicative passage, which makes a detour around the latent image writing position.

28. An image forming apparatus comprising:
a latent image forming unit that forms a latent image on an image carrying body;
a developing unit that visualizes the latent image formed on the image carrying body by using a developer; and
an intermediate transfer member that temporarily holds the visual image formed on the image carrying body and transferring the visual image onto a recording sheet, wherein the recording sheet is transported from a lower part to an upper part;
wherein a developing housing containing the developer is communicatively connected to a developer replenishment box; and
wherein the developing housing and the developer replenishment box are disposed in an upper part of a latent image writing position on the image carrying body.

29. A process cartridge comprising:
an image carrying body;
at least one process unit; and
a developer replenishment box,
wherein the developer replenishment box is communicatively connected to a developing housing; and
wherein the developer replenishment box is disposed in an upstream of a latent image writing position on the image carrying body.

30. A developing unit comprising a housing for containing developer, wherein the housing is communicatively connected to a developer replenishment box.

31. The image forming apparatus according to claim 23, wherein the developing housing is disposed in a lower part of the latent image writing position.
